(19) United States
(12) Patent Application Publication
(10) Pub. No.: US 2011/0228343 A1
(43) Pub. Date: Sep. 22, 2011

(54) IMAGE PROCESSING SYSTEM AND IMAGE SCANNING APPARATUS

(75) Inventors: Kenzo Isogawa, Tokyo (JP); Yasunori Taguchi, Kanagawa-ken (JP); Nao Mishima, Tokyo (JP); Nobuyuki Matsumoto, Tokyo (JP)

(73) Assignee: KABUSHIKI KAISHA TOSHIBA, Tokyo (JP)

(21) Appl. No.: 12/880,705

(22) Filed: Sep. 13, 2010

(30) Foreign Application Priority Data
Mar. 19, 2010 (JP) 2010-65224

(51) Int. Cl. H04N 1/409; H04N 1/04

(52) U.S. Cl. 358/3.27; 358/474

(57) ABSTRACT

In one embodiment, an image data acquisition unit, a filter setting unit and a filtering processor are provided. The image data acquisition unit acquires pixel data of first image data of an erect image obtained by a line sensor comprising a plurality of light receiving elements. The erect image is formed by a plurality of gradient index lenses of a lens array. The filter setting unit sets sharpening filter coefficients of a filter to be applied to the pixel data of the first image data corresponding to the respective light receiving elements, according to remainder values obtained respectively by dividing positions of the light receiving elements on the line sensor by an interval of a lens arrangement of the lens array. The filtering processor generates second image data sharpened by applying the obtained sharpening filter coefficients to the respective pixel data of the first image data.

### CROSS-REFERENCE TO RELATED APPLICATION(S)

This application is based upon and claims the benefit of priority from the prior Japanese Patent Application No. 2010-65224, filed on Mar. 19, 2010, the entire contents of which are incorporated herein by reference.

### FIELD

Embodiments described herein relate generally to an image processing system and an image scanning apparatus which sharpen an image obtained from a line sensor.

### BACKGROUND

A scanner, a facsimile machine, a multifunction peripheral (MFP) and a copying machine are respectively provided with an image scanning apparatus to read a paper document. Some image scanning apparatuses have a contact image sensor (CIS) which is an imaging device employing a contact optical system.

The contact image sensor has a lens array and a line sensor, and reads a document line by line. The CIS is designed so as to bring a document on a scanner platen into focus. Accordingly, when a gap exists between the document and the platen, a scanned image is blurred.

Japanese Patent No. 3028518 discloses a device to perform image sharpening by utilizing a filter coefficient determined by the following steps. Following plural pairs of images are obtained for plural documents, respectively. One of each of the pairs is an image scanned under an ideal condition. The other of each of the pairs is an image scanned under a condition that the documents are intentionally floated. By using the pairs of images, variation of frequency characteristics of the images is estimated. The variation is caused due to gaps between the documents and a platen. Then, a filter coefficient is obtained in order to cancel the variation of frequency characteristic.

### BRIEF DESCRIPTION OF THE DRAWINGS

FIG. 1 is a block diagram of an image processing system according to an embodiment;

FIG. 2 is a flowchart showing an operation of the image processing system according to the embodiment;

FIG. 3 is a view illustrating the configuration of a scanner schematically;

FIG. 4 is an enlarged view illustrating the configuration of a contact image sensor provided in the scanner of FIG. 3 schematically;

FIG. 5 is an enlarged view illustrating a positional relation between light receiving elements and lenses, respectively of a contact image sensor;

FIG. 6 is a view illustrating an example of image data;

FIG. 7 is a block diagram showing a modification of a filter setting unit;

FIG. 8 is a flowchart showing an operation of the filter setting unit shown in FIG. 7;

FIG. 9 is a view to explain a positional relation between light receiving elements arranged in an image sensor; and

FIG. 10 is a view illustrating the configuration of a modification of the contact image sensor.

### DETAILED DESCRIPTION

In one embodiment, an image processing system is provided. The image processing system is provided with an image data acquisition unit, a filter setting unit and a filtering processor. The image data acquisition unit acquires pixel data of first image data of an erect image obtained by a line sensor comprising a plurality of light receiving elements. The erect image is formed by a plurality of gradient index lenses of a lens array. The filter setting unit sets sharpening filter coefficients of a filter to be applied to the pixel data of the first image data corresponding to the respective light receiving elements, according to remainder values obtained respectively by dividing positions of the light receiving elements on the line sensor by an interval of a lens arrangement of the lens array. The filtering processor generates second image data sharpened by applying the obtained sharpening filter coefficients to the respective pixel data of the first image data.

In another embodiment, an image scanning apparatus is provided. The image scanning apparatus is provided with a distance sensor, a scanner and an image processing system. The image processing system is provided with an image data acquisition unit, a filter setting unit and a filtering processor.

The distance sensor measures the distance between an object and a reference plane. The scanner has a line sensor to scan an image. The image data acquisition unit acquires pixel data of first image data of an erect image obtained by a line sensor comprising a plurality of light receiving elements arranged. The erect image is formed by a plurality of gradient index lenses of a lens array.

The filter setting unit sets sharpening filter coefficients of a filter to be applied to the pixel data of the first image data corresponding to the respective light receiving elements, according to remainder values obtained respectively by dividing positions of the light receiving elements on the line sensor by an interval of a lens arrangement of the lens array. The filtering processor generates second image data sharpened by applying the obtained sharpening filter coefficients to the respective pixel data of the first image data.

Hereinafter, further embodiments will be described with reference to the drawings. In the drawings, the same numerals denote the same or similar portions, respectively.

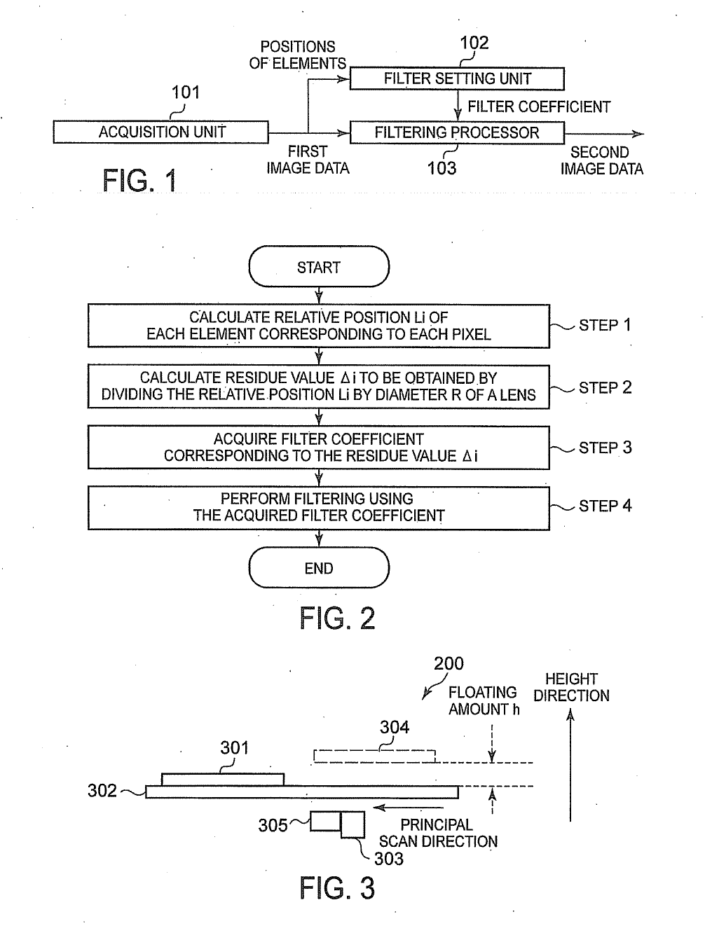

A first embodiment will be described with reference to FIG. 1. FIG. 1 is a block diagram of an image processing system according to the first embodiment.

As illustrated in FIG. 1, the image processing system is provided with an image data acquisition unit 101, a filer setting unit 102 and a filtering processor 103.

The image data acquisition unit 101 obtains first image data as pickup data from a contact image sensor of a scanner, which will be described below. The filter setting unit 102 sets a sharpening filter. The filtering processor 103 obtains a second image data as sharpened image data by performing processing of the first image data with the sharpening filter.

FIG. 3 is a view illustrating the configuration of a main body of a scanner to provide the first image data as the pickup data to the image data acquisition unit 101. In the main body 200 of the scanner, a document 301 is placed on a transparent platen 302 made of glass or the like, and is scanned. The main body 200 and the image processing system of FIG. 1 constitute an image scanning apparatus.

A contact image sensor 303 scans one line of an image, and then, moves to a position to scan the next line. By repeating the scanning and moving, pickup data of the entire document can be obtained. Hereinafter, the moving direction of the contact image sensor 303 is called as a principal scan direction. In FIG. 3, a floating state of a document 304 is also illustrated. The document 304 is floated in a height direction by a floating amount “h”. A distance sensor 305 measures the floating amount “h”, i.e., the distance between an object (the document 304) and a reference plane.

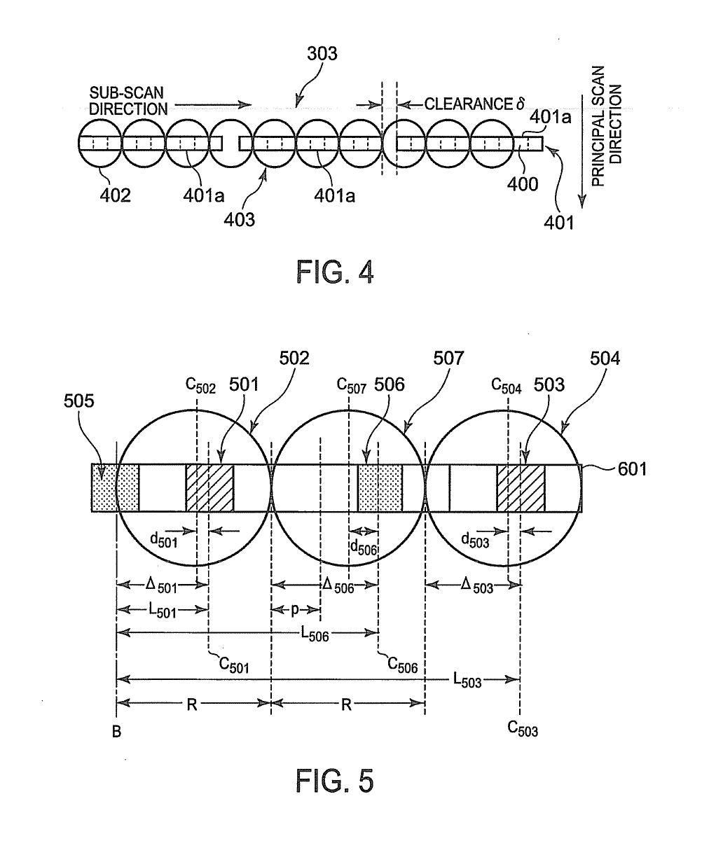

FIG. 4 is an enlarged top view illustrating the configuration of the contact image sensor 303 provided in the main body of the scanner of FIG. 3, schematically. The contact image sensor 303 is provided with an image sensor 401 and a lens array 403 having plural lenses 402.

The image sensor 401 has plural elements, i.e. light receiving elements 400 to obtain image data of one line. The lenses 402 form an erect image on the image sensor 401. The image sensor 401 of the embodiment is a line sensor having the elements arranged on a line.

The lenses 402 of the embodiment are gradient index (GRIN) lenses. The lenses 402 form an erect same-size image on the image sensor 401 respectively. Hereinafter, the arrangement direction of the elements of the image sensor 401 and the lenses 402 is called as a sub-scan direction.

The filter setting unit 102 of FIG. 1 sets a filter coefficient according to a remainder of dividing of a distance between a reference point set on the image sensor 401 of FIG. 4 and the element 400 corresponding to each pixel by the diameter of the lens 401. The reference point set on the image sensor 401 will be described below. The remainder value and the filter coefficient are in one-to-one correspondence. Plural arbitrary remainder values correspond to different filter coefficients respectively.

In FIG. 4, the length in the sub-scan direction of the contact image sensor 303 is almost the same as a size of a target document. In order to support a document of A3 size, the length is required to be several tens of centimeters. Each of the lenses 402 can form an erect same-size image of a limited area of a document. An image of the entire document can be obtained by superimposing images obtained from the respective lenses 402 arranged in an array-shape. Since it is difficult to fabricate an image sensor having a size of several tens of centimeters by one chip, the image sensor 401 comprises plural image sensor units 401a arranged in the sub-scan direction. In fabrication of the image sensor 401, gaps δ may occur between the image sensor units 401a, depending on cases.

The image quality deterioration of the contact image sensor 303 can be characterized by a point spread function (hereinafter, abbreviated as “PSF”). The PSF depends on shapes of the lenses 402 seen from the light receiving elements 400.

FIG. 5 is a partially enlarged view of an example of a contact image sensor. With reference to FIG. 5, the relation between a lens shape and a PSF will be described. In the example, it is assumed that the diameter R of the lenses 502, 504 and 507 and the size p of the elements 501, 503 and 506 satisfy a relation of R=3.5×p. Further, in the example, the end of the left end lens 502 is assumed to be a reference position B, and the center of the left end element 505 of the image sensor is assumed to be the reference position B.

A distance L₅₀₁ from the reference position B to the center C₅₀₁ of the element 501 is 2 p. The center C₅₀₁ of the element 501 is located at a position having a distance Δ₅₀₁ from the left end of the lens 502. Since the reference position B and the left end of the lens 502 is matched in FIG. 5, the distance Δ₅₀₁ is 2 p as well. The lens radius 0.5R is 1.75 p. Accordingly, a distance d₅₀₁ from the center C₅₀₂ of the lens 502 to the center C₅₀₁ of the element 501 is 0.25 p. The center C₅₀₂ of the lens 502 is located on the element 501.

Similarly, since a distance Δ₅₀₃ from the left end of the lens 504 to the center C₅₀₃ of the element 503 is 2 p, a distance d₅₀₃ from the center C₅₀₄ of the lens 504 to the center C₅₀₃ of the element 503 is 0.25 p as well. The center C₅₀₄ of the lens 504 is located on the element 503. Accordingly, the shape of the lens 502 seen from the element 501 is matched with the shape of the lens 504 seen from the element 503. In this case, the PSF obtained for the element 501 is matched with the PSF obtained for the element 503.

On the other hand, since a distance Δ₅₀₆ from the left end of the lens 507 to the center C₅₀₆ of the element 506 is 2.5 p, a distance d₅₀₆ from the center C₅₀₇ of the lens 507 to the center C₅₀₆ of the element 506 is 0.75 p. The center C₅₀₇ of the lens 507 is not located on the element 506. Accordingly, the shape of the lens 507 seen from the element 506 is different from the shape of the lens 502 seen from the element 501. In this case, the PSF obtained for the element 506 is different from the PSF obtained for the element 501.

FIG. 2 is a flowchart showing an operation of the image processing system according to the embodiment.

The image data acquisition unit 101 of FIG. 1 obtains first image data from the contact image sensor 303 of the main body of the scanner illustrated in FIG. 3, and obtains a relative position Lᵢ of the elements 400 that acquire a signal of each pixel to the reference position B (step 1).

In the first image data, since data obtained from respective elements 400 of the image sensor 403 are arranged according to a certain rule, each of the elements that acquires the signal of each pixel can be specified.

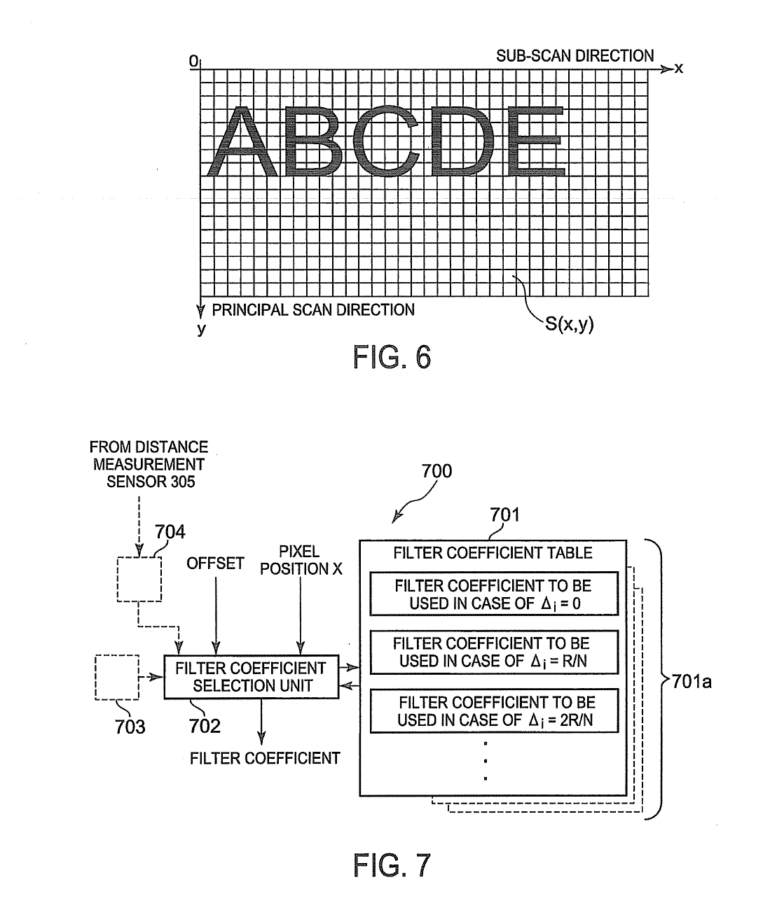

FIG. 6 illustrates an example of the first image data. The first image data includes brightness s(x, y) at each point of a two-dimensional coordinate system (x, y). The “y” denotes a position in the principal scan direction, and the “x” denotes the x-th element counting from an end of the line sensor.

The filter setting unit 102 calculates a remainder value Δᵢ by dividing the relative position Lᵢ, for example, L₅₀₁, L₅₀₃ or L₅₀₆ respectively of the element i, for example, the elements 501, 503 or 506 against the reference position B of FIG. 5, by an interval of the lens arrangement, i.e. the diameter R of the respective lenses (step 2). The remainder value Δᵢ corresponds to the distance Δ₅₀₁, Δ₅₀₃ or Δ₅₀₆, for example. The relative position Lᵢ against the reference position B is required to be matched with the structure of the actual contact image sensor accurately. However, the relative position Lᵢ may deviate from the actual value according to a simple calculation method.

The reference position B that is the left end of the lens 502 is not always located at the left end of the image sensor as illustrated in FIG. 5. As a factor causing such a deviation, error in a manufacturing stage is presumed, for example. The problem can be solved by adding a function to plus an offset that is one real number corresponding to the manufacturing error to the relative position Lᵢ of the element i, to the filter setting unit 102. Since the offset is not changed after the lenses and the image sensor are once connected, the positional deviations between the lenses and the image sensor may be measured in a manufacturing stage, be stored in the image processing system, and be used as the offset.

Further, due to occurrence of the gaps 8 between the respective image sensor units 401a as illustrated in FIG. 4, multiplication of the coordinate x of the image data of FIG. 6 by the element pitch p may not be matched with the relative position Lᵢ of the actual element i. Such a deviation can be corrected when design parameters of the contact image sensor are known.

When the relative position Lᵢ is correctly obtained by performing the above measures, the distance Δᵢ can be defined as the following equation.

Δi=Lᵢ−R×F(Lᵢ/R) (1)

In the equation (1), “F” denotes a function. The function “F” drops the fractional portion of Lᵢ/R. The value range of the distance Δᵢ obtained by the equation (1) is to be equal to or larger than zero and smaller than R. For plural ones of the elements, i.e. the pixels having the same distance Δᵢ, the same PSF can be utilized. In the example of FIG. 5, for example, the distance L₅₀₁ between the pixel 501 and the reference point is 2 p, so that the distance Δ₅₀₁ is calculated to be 2 p by the equation (1). Similarly, in the case of the pixel 503, the distance L₅₀₃ is 9 p, so that the distance Δ₅₀₃ is calculated to be 2 p by the equation (1).

Then, the filter setting unit 102 outputs the filter coefficient corresponding to the distance Δᵢ and the floating amount “h” (step 3). The floating amount “h” is assumed to be measured by the distance sensor 305 previously. As the distance sensor 305, an infrared ray displacement sensor using a triangulation method may be utilized. An inverted filter coefficient calculated from the PSF corresponding to each distance Δᵢ may be utilized for calculation of the filter coefficient corresponding to the distance Δᵢ. When the lens arrangement is fixed according to the floating amount “h” and the distance Δᵢ, the PSF can be estimated by utilizing a ray-tracing method, for example.

The filtering processor 103 of FIG. 1 performs filtering of the first image data obtained from the image data acquisition unit 101 by using the filter coefficient outputted from the filter setting unit 102, and generates second image data relating to the position of the element (pixel) i (step 4). The gaps δ of the image sensor illustrated in FIG. 4 also need to be considered when performing filtering. The effects of the gaps δ will be described with reference to FIG. 9.

FIG. 9 is a view to explain a positional relation between light receiving elements arranged in an image sensor. In FIG. 9, two image sensor units 901, 902 are arranged at an interval of a distance p, which is the same as the pitch of the elements i.e. the pixels of the image sensor units. In the following case, filtering of the width of five pixels in the sub-scan direction and of the width of one pixel in the principal scan direction is performed with respect to imaging results outputted from the image sensor having such a structure, as an example.

Generally, a filter is designed with an assumption that elements i.e. pixels are arranged at constant intervals. Accordingly, in the case that a filtering result is obtained corresponding to the position of the element 905, for example, filtering can be performed without a problem by using imaging data obtained from the elements 903, 904, 905, 906 and 907. However, any element does not exist at a position apart from the element 906 by 2 p in the direction opposite to the element 904, so that filtering cannot be performed. In order to resolve the problem, it is sufficient only to interpolate a signal from the position apart from the element 906 by 2 p in the direction opposite to the element 904. For example, an average of the signals from the elements 907, 908 may be used as a pixel signal from the position where any element i.e. any pixel does not exist.

For performing such pixel signal interpolation, the interval between the image sensor units 901, 902 is integer times of the element pitch i.e. the pixel pitch p, desirably. In the case that the interval between the elements 907, 908 is 1.5 p, for example, interpolation processing of two times is required to perform filtering of the pixel 907. This is because any element does not exist at a position apart from the element 907 by 1 p in the direction opposite to the element 906 as well as at the position apart by 2 p.

The above processing may be unnecessary in the case that the gaps 6 of the image sensor units is interpolated at a contact image sensor side as a imaging device or in the case that calculation of an inverted filter coefficient is executable according to the pixel arrangement.

As described above, in the image processing system according to the first embodiment, filtering is performed using the same filter coefficient for plural points having the same interval as the diameter R of the lenses 502, 507 and 504. Otherwise, filtering is performed using a different filter coefficient. In this manner, filtering processing is performed according to PSF variation depending on scanning position, so that image quality of a reproduced result i.e. a reproduced image can be enhanced.

In the above description of the embodiment, an image sensor having lenses arranged on one line is used, for an example, as illustrated in FIG. 4. it is also possible to adopt

An image sensor having lenses arranged on two lines may be used, as illustrated in FIG. 10. Since this image sensor has a repetition structure where the intervals of lenses are determined by a diameter or a radius of the lenses, the image sensor can adopt the image processing described above. When an imaging device is provided with an optical system having a repeated interval structure, the imaging device can adopt the image processing described above by replacing the above diameter R of the lenses with an interval of the structure of the optical system structure.

The filter setting unit 102 of FIG. 1 can be used in the forms of the following modifications.

In the above embodiment, as an offset to be added to the relative position Lᵢ of an element i, a measurement result of the relative position of an image sensor and lenses is used. The filter setting unit may store an offset in a memory provided in a filter coefficient selecting unit which will be described below, and may use the offset stored in the memory. The offset is one which brings a favorable image quality. Such an offset may be determined by verifying image-processed results while varying the value of the offset at a stage when a contact image sensor as an imaging device and an image processing system are connected.

Calculation of the inverted filter coefficient described in the above embodiment requires a high calculation cost. It is also possible that a filter setting unit 102 previously calculates and stores inverted filter coefficients as a table and brings up an appropriate filter coefficient depending on an inputted distance Δᵢ in order to reduce a calculation cost.

FIG. 7 is a block diagram of a modification of the filter setting unit. As illustrated in FIG. 7, a filter setting unit 700 is provided with a filter coefficient table 701 and the filter coefficient selecting unit 702.

The filter coefficient table 701 stores N pairs of previously calculated inverted filter coefficients and the corresponding distances Δᵢ. The filter coefficient selecting unit 702 selects an appropriate filter coefficient from the filter coefficient table 701, based on an inputted pixel position x, an offset, and data from a distance input unit 704 which receives a measurement result from the distance measurement sensor 305. The filter coefficient table 701 can store filter coefficients for N pieces of filters. The filter coefficient corresponding to the distance Δᵢ(=(k−1)×R/N) is stored in a k-th block of the table. In the above formula, “N” and “k” are positive integers.

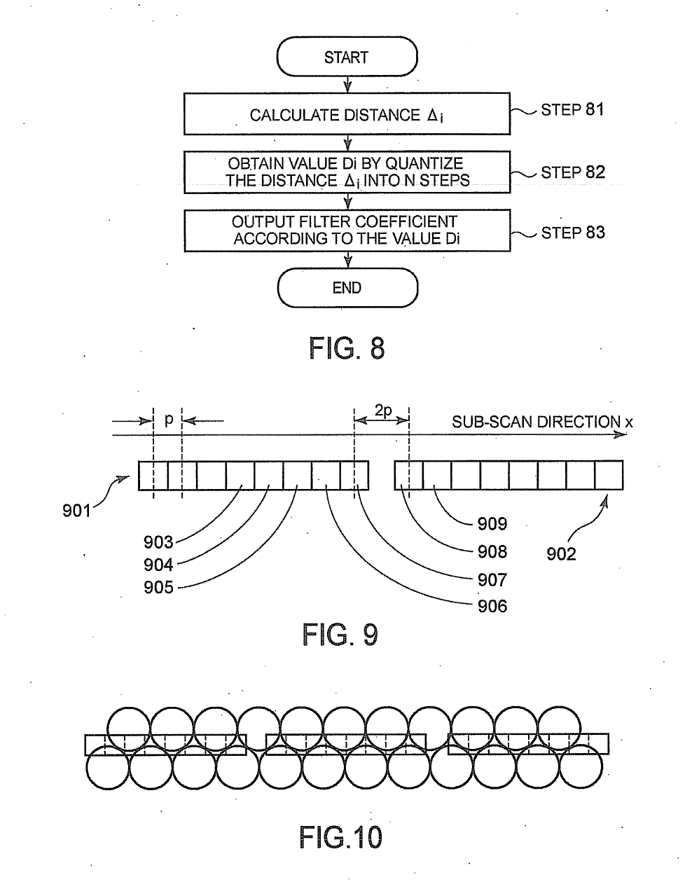

FIG. 8 is a flowchart to explain an operation of the filter setting unit 700. The filter coefficient selecting unit 702 calculates a distance Δᵢ in a processing manner similar to that of the above mentioned embodiment (step 81). Then, a quantized value Dᵢ is obtained by quantizing the obtained distance Δᵢ into N-steps (step 82). For rounding on quantization, round-off, can be used, for example. Further, the filter coefficient selecting unit 702 outputs a filter coefficient stored in the k-th block of the filter coefficient table 701 corresponding to the quantized value Dᵢ (step 83). Accordingly, an appropriate filter coefficient can be obtained at a low calculation cost.

The filter setting unit may include plural filter coefficient tables 701a as illustrated with broken lines in FIG. 7. The filter coefficient tables 701a may be switched according to a floating amount “h” of a document shown in FIG. 3 and a type of the contact image sensor connected to the image processing system of the above embodiment.

The filter coefficient tables 701a is capable of storing filter coefficients corresponding to different floating amounts, lens diameters i.e. intervals of a lens arrangement, pixel sizes or arrangement intervals of elements, and arrangement intervals of image sensor units in advance. Thus, the filter coefficient tables 701a allows the image processing system to perform filtering appropriately even when various floating amounts occur or the contact image sensor is made by a different design.

The design parameter acquisition unit 703 can obtain the different floating amounts, the lens diameter i.e. the interval of the lens arrangement, the pixel sizes or the arrangement intervals of elements, and the arrangement intervals of the image sensor units, and provides them to the filter coefficient selecting unit 702, so that an appropriate table can be selected from the tables 701a.

The filter setting unit may previously learn a filter coefficient to minimize the square error between data of an image of a document scanned under an ideal condition and a filtering result of an image of the same document scanned under a condition that the document is intentionally floated.

Plural filter coefficients whose relation with the distance Δᵢ is learned previously may be stored in the filter coefficient table 701 of FIG. 7, and one of the stored filter coefficients may be read according to the distance Δᵢ. Accordingly, by utilizing the previously learned filter coefficients, parameters necessary to set a filter can be reduced. In the case that filter coefficients are set by performing a ray-tracing, for example, information such as refraction indexes of lenses is required. However, such information is not required in the above case of selecting from the previously learned filter coefficients.

The filter coefficient selecting unit 702 of FIG. 7 may be operated assuming that the offset mentioned above is always constant. Such an assumption allows input of the offset to the unit 702 to be unnecessary. Such an assumption is effective when an image sensor used for obtaining data to learn a filter coefficient and an image sensor used actually are same, in the case that the tables store filter coefficients corresponding to different floating amounts, lens diameters and pixel sizes, for example, previously, as described above.

The image processing system of the above embodiment can be also realized by using a computer for general use as basic hardware. The image data acquisition unit 101 may be an external interface of the computer, and the filter setting unit 102 and the filtering processor 103 may be realized by executing a program with a processor installed in the computer. At that time, the image processing system may be realized also by installing the program in the computer in advance. Instead, the image processing system can be realized by installing the program in the computer appropriately, for example, by storing the program in a storage medium such as a CD-ROM or by distributing the program via a network.

Further, the filter setting unit 102 and the filtering processor 103 can be realized by appropriately utilizing a storage medium attached internally or externally to the computer, such as a memory, a hard disk, a CD-R, a CD-RW, a DVD-RAM and a DVD-R.

While certain embodiments have been described, these embodiments have been presented by way of example only, and are not intended to limit the scope of the inventions. Indeed, the novel systems and apparatuses described herein may be embodied in a variety of other forms; furthermore, various omissions, substitutions and changes in the form of the systems and apparatuses described herein may be made without departing from the spirit of the inventions. The accompanying claims and their equivalents are intended to cover such forms or modifications as would fall within the scope and spirit of the inventions.

What is claimed is:

1. An image processing system comprising:
an image data acquisition unit configured to acquire pixel data of first image data of an erect image obtained by a line sensor comprising a plurality of light receiving elements, the erect image being formed by a plurality of gradient index lenses of a lens array;
a filter setting unit configured to set sharpening filter coefficients of a filter to be applied to the pixel data of the first image data corresponding to the respective light receiving elements, according to remainder values obtained respectively by dividing positions of the light receiving elements on the line sensor by an interval of a lens arrangement of the lens array; and
a filtering processor configured to generate second image data sharpened by applying the obtained sharpening filter coefficients to the respective pixel data of the first image data.

2. The image processing system according to claim 1,
wherein the filter setting unit sets the filter coefficients after shifting values of the distances indicating respective positions of the light receiving elements from a first or second reference position to the respective light receiving elements by an amount of deviation amount between the first reference position on the line sensor and the second reference position on the lens array, as an offset value.

3. The image processing system according to claim 2, further comprising a distance input unit configured to input a distance between an object and a reference plane,
wherein the filter setting unit sets filter coefficients corresponding to the respective remainder values and the distance between the object and the reference plane.

4. The image processing system according to claim 3, further comprising a design parameter acquisition unit, wherein
the line sensor comprises plural image sensor units,
the design parameter acquisition unit acquires at least one of an arrangement interval of the lenses, a size or an arrangement interval of the light receiving elements, and an arrangement interval of the image sensor units, and
the filter setting unit sets a different filter coefficient in a case that at least either of the arrangement interval of the lenses and the size or the arrangement interval of the light receiving elements is different.

5. The image processing system according to claim 1, wherein
the value indicating at least one of a position of the light receiving elements on the line sensor and a position of the lenses on the lens array is varied,
a value showing a favorable obtained image is stored in a memory as an offset value, and
a sharpening filter coefficient is set by the stored offset value.

6. The image processing system according to claim 2,
wherein the sharpening filter coefficient is set based on the offset value and a position of the light receiving elements.

7. The image processing system according to claim 1, wherein
the line sensor comprises plural image sensor units,
the filter setting unit is provided with a filter coefficient selecting unit and at least one filter coefficient table,
the filter coefficient table stores sharpening filter coefficients corresponding to difference of a floating amount, a lens diameter or a lens arrangement interval, a pixel size or an arrangement interval of the light receiving elements, or an arrangement interval of the image sensor units, and
the filter coefficient selecting unit selects an appropriate filter coefficient from the filter coefficient table, based on the floating amount, the lens diameter or the lens arrangement interval, the pixel size or the arrangement interval of the light receiving elements, the arrangement interval of the image sensor units, and a position of the light receiving elements, and outputs the selected filter coefficient to the filtering processor.

8. The image processing system according to claim 1, wherein
the line sensor comprises plural image sensor units,
the filter setting unit is provided with a filter coefficient selecting unit, at least one filter coefficient table, and a design parameter acquisition unit,
the filter coefficient table stores sharpening filter coefficients corresponding to difference of a floating amount, a lens diameter or a lens arrangement interval, a pixel size or an arrangement interval of the light receiving elements, or an arrangement interval of the image sensor units,
the design parameter acquisition unit obtains the floating amount, the lens diameter or the lens arrangement interval, the pixel size or the arrangement interval of the light receiving elements, and the arrangement interval of the image sensor units, as a design parameter, and provides the design parameter to the filter coefficient selecting unit, and
the filter coefficient selecting unit selects an appropriate filter coefficient from the filter coefficient table based on the design parameter and a position of the light receiving elements, and outputs the selected filter coefficient to the filtering processor.

9. The image processing system according to claim 7,
wherein the filter coefficient selecting unit calculates a distance between the end of each of the lenses and the center of each of the light receiving elements, quantizes a value of the obtained distance, selects a filter coefficient corresponding to the quantized value, and outputs to the selected filter coefficient to the filtering processor.

10. The image processing system according to claim 8,
wherein the filter coefficient selecting unit calculates a distance between the end of each of the lenses and the center of each of the light receiving elements, quantizes a value of the obtained distance, selects a filter coefficient corresponding to the quantized value, and outputs the selected filter coefficient to the filtering processor.

11. An image scanning apparatus comprising:
a distance sensor to measure the distance between an object and a reference plane;
a scanner having a line sensor to scan an image; and
an image processing system including:
an image data acquisition unit configured to acquire pixel data of first image data of an erect image obtained by a line sensor comprising a plurality of light receiving elements, the erect image being formed by a plurality of gradient index lenses of a lens array;
a filter setting unit configured to set sharpening filter coefficients of a filter to be applied to the pixel data of the first image data corresponding to the respective light receiving elements, according to remainder values obtained respectively by dividing positions of the light receiving elements on the line sensor by an interval of a lens arrangement of the lens array; and
a filtering processor configured to generate second image data sharpened by applying the obtained sharpening filter coefficients to the respective pixel data of the first image data.

12. The image scanning apparatus according to claim 11, wherein
wherein the filter setting unit sets the filter coefficients after shifting values of the distances indicating respective positions of the light receiving elements from a first or second reference position to the respective light receiving elements by an amount of deviation amount between the first reference position on the line sensor and the second reference position on the lens array, as an offset value.

13. The image scanning apparatus according to claim 12,
wherein the filter setting unit sets filter coefficients corresponding to the respective remainder values and the distance between the object and the reference plane.

14. The image scanning apparatus according to claim 13, further comprising a design parameter acquisition unit, wherein
the line sensor comprises plural image sensor units,
the design parameter acquisition unit obtains at least one of an arrangement interval of the lenses, a size or an arrangement interval of the light receiving elements, and an arrangement interval of the image sensor units, and
the filter setting unit sets a different filter coefficient in a case that at least either of the arrangement interval of the lenses and the size or the arrangement interval of the light receiving elements is different.

15. The image scanning apparatus according to claim 11, wherein
the value indicating at least one of a position of the light receiving elements on the line sensor and a position of the lenses on the lens array is varied,
a value showing a favorable obtained image is stored in a memory as an offset value, and
a sharpening filter coefficient is set by the stored offset value.

16. The image scanning apparatus according to claim 12,
wherein the sharpening filter coefficient is set based on the offset value and a position of the light receiving elements.

17. The image scanning apparatus according to claim 11, wherein
the line sensor comprises plural image sensor units,
the filter setting unit is provided with a filter coefficient selecting unit and at least one filter coefficient table,
the filter coefficient table stores sharpening filter coefficients corresponding to difference of a floating amount, a lens diameter or a lens arrangement interval, a pixel size or an arrangement interval of the light receiving elements, or an arrangement interval of the image sensor units, and
the filter coefficient selecting unit selects an appropriate filter coefficient from the filter coefficient table, based on the floating amount, the lens diameter or the lens arrangement interval, the pixel size or the arrangement interval of the light receiving elements, the arrangement interval of the image sensor units, and a position of the light receiving elements, and outputs the selected filter coefficient to the filtering processor.

18. The image scanning apparatus according to claim 11, wherein
the line sensor comprises plural image sensor units,
the filter setting unit is provided with a filter coefficient selecting unit, at least one filter coefficient table, and a design parameter acquisition unit,
the filter coefficient table stores sharpening filter coefficients corresponding to difference of a floating amount, a lens diameter or a lens arrangement interval, a pixel size or an arrangement interval of the light receiving elements, or an arrangement interval of the image sensor units,
the design parameter acquisition unit obtains the floating amount, the lens diameter or the lens arrangement interval, the pixel size or the arrangement interval of the light receiving elements, and the arrangement interval of the image sensor units, as a design parameter, and provides the design parameter to the filter coefficient selecting unit, and
the filter coefficient selecting unit selects an appropriate filter coefficient from the filter coefficient table based on the design parameter and a position of the light receiving elements, and outputs the selected filter coefficient to the filtering processor.

19. The image scanning apparatus according to claim 17,
wherein the filter coefficient selecting unit calculates a distance between the end of each of the lenses and the center of each of the light receiving elements, quantizes a value of the obtained distance, selects a filter coefficient corresponding to the quantized value, and outputs to the selected filter coefficient to the filtering processor.

20. The image scanning apparatus according to claim 18,
wherein the filter coefficient selecting unit calculates a distance between the end of each of the lenses and the center of each of the light receiving elements, quantizes a value of the obtained distance, selects a filter coefficient corresponding to the quantized value, and outputs to the selected filter coefficient to the filtering processor.
